(19) United States
(12) Patent Application Publication
(10) Pub. No.: US 2007/0011921 A1
(43) Pub. Date: Jan. 18, 2007

(54) Promotional erasable memo board with detachable coupons

(76) Inventor: Jay Wheeler, Montreal (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/442,403

(22) Filed: May 30, 2006

Related U.S. Application Data
(60) Provisional application No. 60/699,874, filed on Jul. 18, 2005.

(51) Int. Cl. G09F 1/00

(52) U.S. Cl. 40/124.09

(57) ABSTRACT

A promotional product comprising at least two, preferably, three panels, namely a durable and retainable central panel with two peripheral panels hingedly attached thereto. The central panel is durable and advantageously carries an erasable memo board with and appropriate marker in a holder, and the side panels bear promotional material, which may be in the form of redeemable coupons detachably mounted, for example by perforations, for ease of removal and use.

### CROSS REFERENCE TO RELATED APPLICATIONS

Benefit of U.S. Provisional Application for Patent Ser. No. 60/699,874, filed on Jul. 18, 2005, is hereby claimed.

### FIELD OF THE INVENTION

The present invention relates in general to promotional bulk mail and more specifically to promotional bulk mail merchandising material that is magnetically mountable on appliances and is additionally provided with merchandise/product/service offers that are in the form of detachable coupons subsequently redeemable for cash value on the purchase of the product/merchandise/service as advertised in the bulk mail.

### BACKGROUND OF THE INVENTION

Promotional bulk mail merchandising has long been a nuisance and a bane to many potential consumers due to its proliferation and shoddy nature. More often than not it is discarded immediately without even being considered. However, this kind of marketing persists because there are enough consumers who do take advantage of the offers therein provided. Clearly the bottom line of any marketing strategy is to make the sale and in the domain of bulk mail promotional merchandising, imaginative innovations have become an imperative. This imperative has led to such innovations as sturdier, more substantial circulars provided with fridge magnets. The intention in all these cases is to make the mailer appear to be an item of value such as something to be saved and referred to in the event that the consumer will ultimately make the desired purchase. In many instances this strategy has worked but the underlying reality is that over time, the product (promotional merchandising in the form of brochures, flyers and the like) does not stand up to the rigors of handling and display and is eventually discarded before its offers can be advantaged. Promotional and advertising funds are thereby disbursed incommensurate with the level of return.

Various types of promotional articles are already known. For example U.S. Pat. No. 4,685,699 to Hirasawa proposes the combination of a high quality incentive gift for the recipient coupled with the provision of a number of detachable coupons relating to the products which are the subject of the promotion. U.S. Pat. No. 5,868,498 to Martin discloses a magnetic pocket card into which appropriate promotional material may be inserted, and U.S. Pat. No. 6,273,660 to Ozgen et al concerns a flexible magnetic insert removeably bound into a magazine and carrying a number of coupons which may be separated as and when required, the sheet being conveniently stored for example on a refrigerator door or file cabinet.

These prior art examples are specially focused on particular functions and do not thus have a wide applicability in the general field of promotional bulk mail merchandising to which the present invention relates.

A general advantage of the present invention is the provision of an innovative construction of a promotional product, suitable inter alia for bulk mail distribution, which offers a durable element coupled with advertising information and redeemable coupons.

A further advantage of the present invention is that it obviates the aforementioned disadvantages of conventional promotional circulars and serves to be multi-functional whilst retaining the promotional aspects inherent in the principal purpose of the product.

### SUMMARY OF THE INVENTION

It is therefore a general object of the present invention to provide a durable promotional product that will serve to promote specific products and services and be retained and consulted by the consumer.

A further object of the present invention is to provide a useful element for retention by the consumer that will survive the promotional term thereof.

Accordingly the invention provides a promotional product comprising a planar blank having at least two separate foldable reinforced panels hingedly attached together and adapted to carry promotional text on the obverse and reverse sides thereof.

Conveniently and generally the planar blank will have a triptych formation.

Preferably at least one of the peripheral panels would have a series of hingedly detachable promotional offer coupons redeemable in cash value for merchandise/products/services on the obverse side. Additional information would be printed on the reverse side of said detachable coupons.

Advantageously the product has a central panel, in the case of the triptych formation, said panel comprising an erasable memo board on the obverse side provided with a snap-fit felt-tipped marker and commercial information relating to products/services on the reverse side.

The inclusion of the third (peripheral) panel provides the opportunity for promotional information to be carried on both obverse and reverse sides. This third panel may conveniently be hingedly attached to the central panel by a reinforced plastic spine.

The present invention further provides for the inclusion of flexible vinyl magnetic attachment units on the reverse side of the central panel of the planar board to allow for mounting on any metallic surface.

The promotional product of the present invention as intimated may be available in several embodiments to respond to varying promotional and advertising needs, for example the triptych formation or indeed a diptych formation. It will be understood that any number of panels, within the bounds of practicality may be adopted with suitable articulation between adjacent panels.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a frontal view showing an obverse side of a promotional product in accordance with an embodiment of the present invention as it would appear in the unfolded configuration;

FIG. 2 is a frontal view of another embodiment of the present invention;

FIG. 3 is frontal view of a reverse side of the embodiment of FIG. 1;

FIG. 4 is a top front perspective view of another embodiment shown in a semi-folded configuration; and

FIG. 5 is an enlarged top diagrammatic view of the embodiment of FIG. 4 shown in almost fully folded configuration.

### DETAILED DESCRIPTION OF THE PREFERRED EMBODIMENTS

With reference to the annexed drawings the preferred embodiment of the present invention will be herein described for indicative purpose and by no means as of limitation.

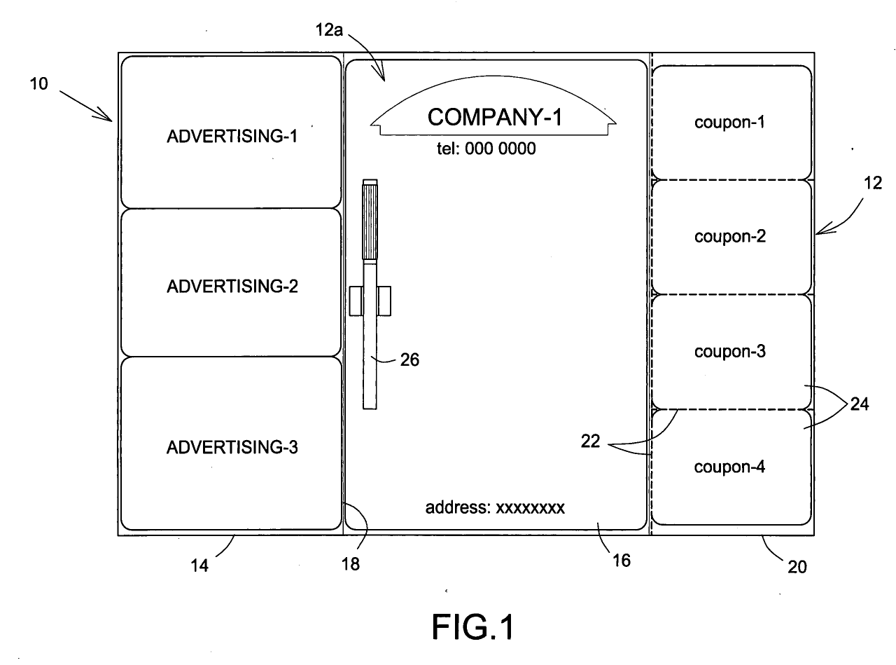

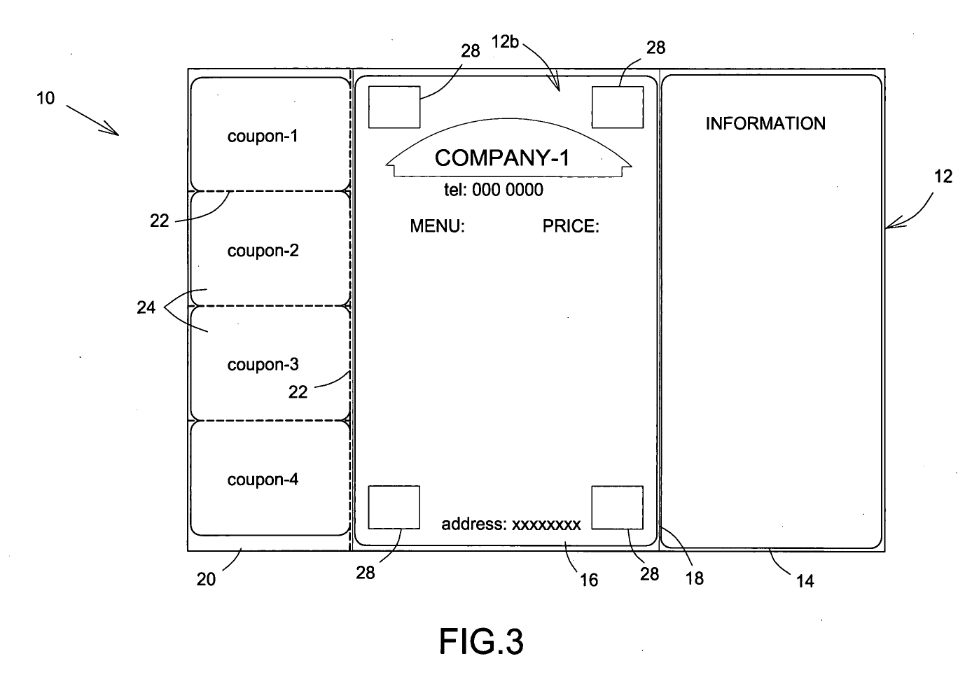

FIGS. 1 and 3 show a promotional product 10 in accordance with an embodiment of the present invention composed of a plastic laminated planar blank 12 of durable, cardboard paper with both an obverse side 12a and a reverse side 12b (see FIG. 3), shown in an unfolded configuration. The panel blank 12 is in triptych formation and is comprised of three foldable, hingedly attached panels, the first panel being a peripheral ‘ad’ text panel 14 bearing promotional text printed on both the obverse side 12a and the reverse side 12b and being reinforceably secured to a central panel 16 by a plastic spine 18. The central panel 16 on the obverse side serves as a memo board having a plasticized surface, for example a ‘white board’, allowing for easy erasure of any text applied to it with the snap-fit felt-tipped marker 26 (see below). A second peripheral panel is the peripheral coupon panel 20 and is hingedly attached to the central panel 16 by a series of serrated perforation edges 22 well known in the art. The peripheral coupon panel 20 is comprised of a number of detachable coupons 24 with printed matter on both the obverse 12a and reverse 12b sides of the planar blank 12, said coupons 24 being detachable and ultimately redeemable for the advertised merchandise/product/service printed thereon.

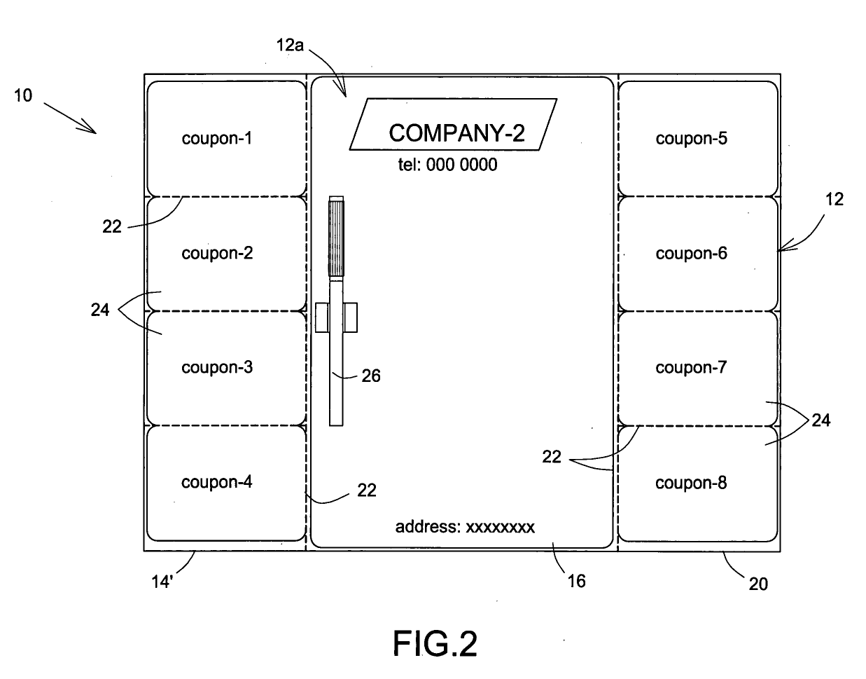

In FIG. 2, there is shown a second embodiment similar to the embodiment of FIG. 1 with the exception that the first peripheral panel 14 is another peripheral coupon panel 14′ similar to the second peripheral coupon panel 20.

Also pictured in FIGS. 1, 2, 3 and 4 and located on the right obverse side of the central panel 16 is a felt-tipped snap-fit marker assembly 26 well known in the art which is adhesively affixed to the surface of the obverse side 12a of the central panel 16. FIG. 3 shows the reverse side of the planar blank 12 of FIG. 1 illustrating the location of the flexible vinyl magnets 28, which are adhesively affixed to the reverse side 12b of the central panel 16 of the planar blank 12. The vinyl magnets 28 allow for the promotional product 10 to be mounted securely on any metallic surface. Also shown in FIG. 3 is text copy printed on the reverse side of the peripheral coupon panel 24 and related information printed on the reverse side of the central panel 16 and the peripheral text panel 14.

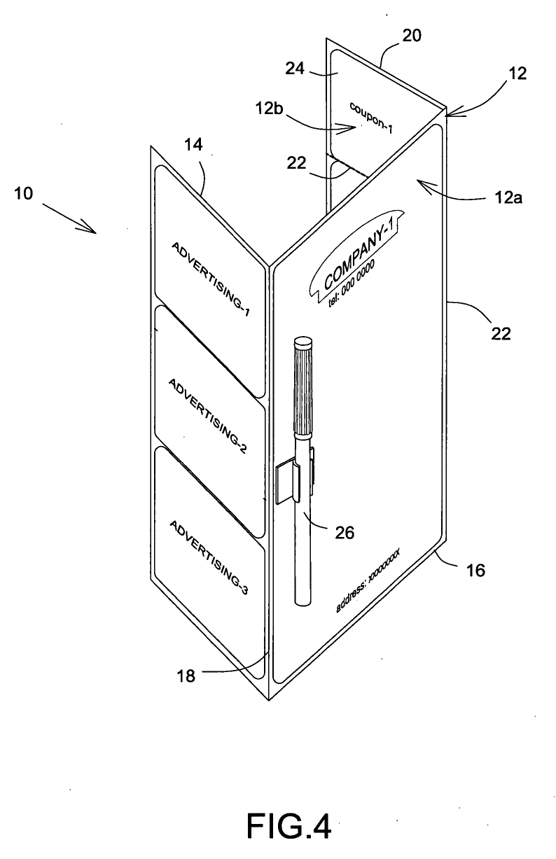

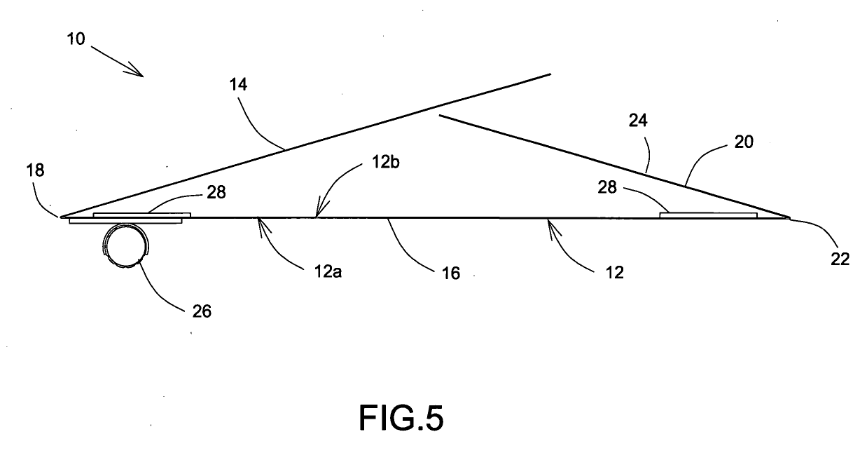

FIGS. 4 and 5 show another embodiment in a substantially semi-folded configuration and an almost fully folded configuration, respectively. In the folded configuration, the product 10 can easily be inserted into an envelope for mailing purposes, for example.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A promotional product comprising a planar blank having at least two separate foldable reinforced panels hingedly attached together and adapted to carry promotional text on the obverse and reverse sides thereof.

2. A promotional product according to claim 1 wherein the planar blank is of triptych formation comprising a central panel and two peripheral panels.

3. A promotional product according to claim 2 wherein at least one of the peripheral panels comprises a series of hingedly detachable promotional offer coupons redeemable in cash value for at least one of merchandise, products or services on the obverse side.

4. A promotional product according to claim 3 wherein the said at least one peripheral panel carries additional information on the reverse side of the coupons.

5. A promotional product according to claim 2 wherein the central panel comprises on its obverse side an erasable memo board and carries a snap-fit felt-tipped marker.

6. A promotional product according to claim 5 wherein the central panel carries on its reverse side commercial information.

7. A promotional product according to claim 3 wherein the other of said peripheral panels is adapted to carry promotional information on both the obverse and reverse sides thereof.

8. A promotional product according to claim 7 wherein said other peripheral panel is hingedly attached to the central panel by a reinforced plastic spine.

9. A promotional product according to claim 2 wherein the central panel is provided with a number of flexible vinyl magnetic attachment units on the reverse side thereof, thereby adapting the product for mounting on a metallic surface.
